(19) United States
(12) Patent Application Publication
(10) Pub. No.: US 2016/0269841 A1
(43) Pub. Date: Sep. 15, 2016

(54) ALERT BASED ON RECOGNITION OF A PARTICULAR SOUND PATTERN

(71) Applicant: Nvidia Corporation, Santa Clara, CA (US)

(72) Inventor: Amol SHINDE, Pune (IN)

(21) Appl. No.: 14/643,730

(22) Filed: Mar. 10, 2015

(51) Int. Cl. H04R 29/00; H04R 1/10

(52) U.S. Cl. CPC H04R 29/00; H04R 1/1091

(57) ABSTRACT

Alert based on recognition of a particular sound pattern. In accordance with another embodiment of the present invention, an apparatus includes a sound source device for playing an audio program to headphones and an acoustic sound receiver coupled to the sound source device for receiving external audio. The sound source device is operable to match received external audio to at least one of a plurality of registered sound patterns and generate an audio alert message to the headphones responsive to such a match.

### FIELD OF INVENTION

Embodiments of the present invention relate to the field of digital signal processing. More specifically, embodiments of the present invention relate to systems and methods for alerts based on recognition of a particular sound pattern.

### BACKGROUND

Listening to sound sources, e.g., portable music players, mobile telephones, electronic games and the like, through headphones or “ear buds” is ubiquitous. Modern headphones or ear buds deliver high quality sound without disturbing others in the immediate area.

Unfortunately, using such headphones or ear buds may also isolate a listener from the exterior acoustic environment. For example, a person listening to a device via headphones or ear buds may not be able to hear important nearby sounds.

### SUMMARY OF THE INVENTION

Therefore, what is needed are systems and methods for alerts based on recognition of a particular sound pattern. What is additionally needed are systems and methods for alerts based on recognition of a particular sound pattern that interrupt an audio program being played over headphones. A further need exists for systems and methods for alerts based on recognition of a particular sound pattern that are compatible and complementary with existing systems and methods of electronic device design and manufacture, and digital signal processing. Embodiments of the present invention provide these advantages.

In accordance with a first method embodiment, received external audio is accessed while playing an audio program to headphones. The received external audio is matched to at least one of a plurality of registered sound patterns. Responsive to matching the external audio to a registered sound pattern, an audio alert message is generated to the headphones. The audio alert message may mute the audio program and may include the received external audio.

In accordance with another embodiment of the present invention, an apparatus includes a sound source device for playing an audio program to headphones and an acoustic sound receiver coupled to the sound source device for receiving external audio. The sound source device is operable to match received external audio to at least one of a plurality of registered sound patterns and generate an audio alert message to the headphones responsive to such a match.

In accordance with a further embodiment of the present invention, an article of manufacture includes a computer readable media. The computer readable media includes instructions that, responsive to execution by a computer system, cause the computer system to perform operations including accessing received external audio while playing an audio program to headphones, matching the received external audio to at least one of a plurality of registered sound patterns and generating an audio alert message to the headphones responsive to the matching.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary configuration of a person listening to a sound source, in accordance with the conventional art.

FIG. 2 illustrates an exemplary configuration of a person listening to a sound source device, in accordance with embodiments of the present invention.

FIG. 3 illustrates a method, in accordance with embodiments of the present invention.

FIG. 4 is an exemplary block diagram of an exemplary electronic system, which may be used as a platform to implement embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation and Nomenclature

Some portions of the detailed descriptions which follow (e.g., method 300) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “playing” or “matching” or “generating” or “performing” or “determining” or “comparing” or “setting” or “accessing” or “placing” or “testing” or “forming” or “mounting” or “removing” or “ceasing” or “stopping” or “coating” or “attaching” or “processing” or “adjusting” or “creating” or “executing” or “continuing” or “indexing” or “computing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Alerts Based on Recognition of a Particular Sound Pattern

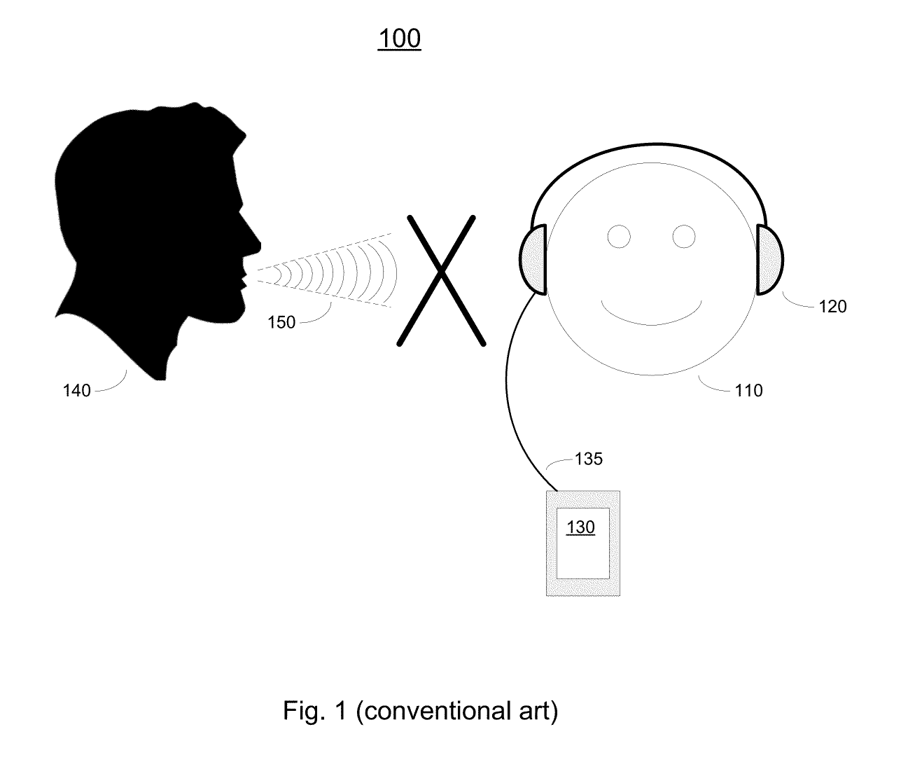

FIG. 1 illustrates an exemplary configuration 100 of a person 110 listening to a sound source 130, in accordance with the conventional art. In general, sound source 130 provides an audio program to a listener 110 via headphones 120. The audio program may be a recording, e.g., music or video playback, or may be generated in substantially real time, e.g., game sounds. The audio program may be a part of a program comprising video content. Sound source 130 may be a digital music player, e.g., an MP3 player. Sound source 130 may be an analog music player, e.g., a cassette tape player. Sound source 130 may be a mobile telephony device, e.g., a “smart” phone. Sound source 130 may be a gaming device. Sound source 130 may also comprise “wearable” devices, e.g., a “smart” watch or head-mounted computer, e.g., “glasses.” Sound source 130 is not required to be a portable device. For example, sound source 130 may be a game console device or a personal computer. It is appreciated that sound source 130 may be a part of or embedded in headphones 120. In summary, sound source 130 may be almost any source of sound adaptable to listening through headphones, ear buds and/or speakers placed close to a listener's ear or ears.

Headphones 120 provide acoustical sound from sound source 130 to user 120. Headphones 120 may comprise any suitable transducers, and may include “in,” “on,” “near” and/or “over” the ear devices. For example, headphones 120 may include “ear buds,” which are placed substantially in a listener's ear(s). Headphones 120 may also include “over the ear” devices. Sound source 130 is functionally coupled to headphones 120 via coupling 135. Coupling 135 may be any coupling, including wired and wireless couplings, including, for example, infrared (IR) light and radio frequency, e.g., Bluetooth, couplings.

Headphones 120 generally provide a high degree of isolation from ambient sound. For example, ambient sound impinging on listener 110 is greatly reduced due to a fit into an external ear canal and/or covering an external ear by headphones 120. Due to such high isolation from ambient sound provided by headphones 120, listener 110 is unable to hear, recognize and/or understand external acoustic sound 150 from external source 140. A relative volume level of audio from headphones 120 may also contribute to listener 110's inability to hear, recognize and/or understand external acoustic sound 150 from external source 140.

External acoustic sound 150 may be any acoustic sound that listener 110 may or should consider important. For example, external acoustic sound 150 may be speech from a friend, co-worker and/or boss. External acoustic sound 150 may be an announcement or emergency message transmitted via a pubic address (PA) system. External acoustic sound 150 may be a non-speech warning signal, such as a car or train horn, or an emergency vehicle siren.

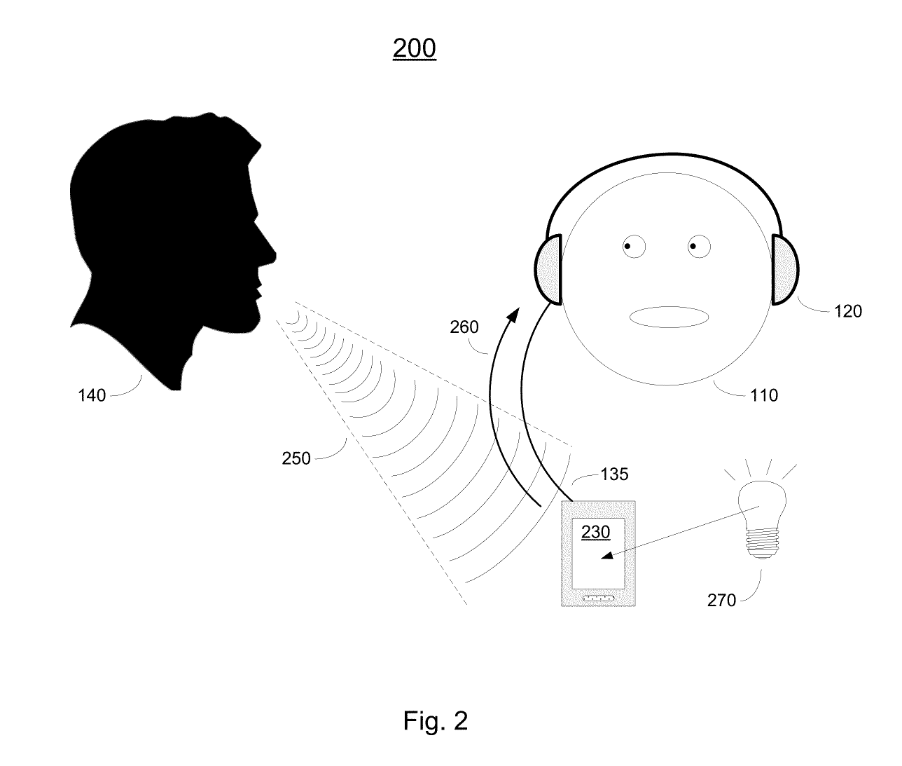

FIG. 2 illustrates an exemplary configuration 100 of a person 110 listening to a sound source device 230, in accordance with embodiments of the present invention. Sound source device 230 is generally similar to sound source 130. In addition to the sound generating and/or reproduction capabilities of sound source 130, sound source device 230 comprises an acoustic sound receiver 236, e.g., a microphone, and signal processing capabilities. It is appreciated that embodiments in accordance with the present invention do not require that sound source device 230 and headphones 120 are physically separate. Embodiments in accordance with the present invention are well suited to sound source device 230 and/or acoustic sound receiver 236 being a part of, or embedded into, headphones 120. For example, active “noise canceling” headphones may comprise an acoustic sound receiver 236 and audio processing circuitry, and may be adapted to receive audio programming from an external source, e.g., an MP3 player.

External acoustic sound 250 is generally similar to external acoustic sound 150. External acoustic sound 250 may be generated by similar sources as external acoustic sound 150, and may comprise the same or similar content, including non-speech content, as external acoustic sound 150. Both external acoustic sounds 150 and 250 may be directed, e.g., by a speaker, in similar directions, e.g., toward listener 110.

External acoustic sound 250 is received by acoustic sound receiver 236 of sound source 230. Sound source device 230 processes external acoustic sound 250 to determine if one or more particular sound patterns are present in acoustic sound 250. Responsive to the presence of one or more particular sound patterns in acoustic sound 250, an audio alert message 260 is sent over coupling 135 from sound source device 230 to headphones 120 to alert listener 110. Optionally, an audio alert message 260 may not be generated if the listener 110 is listening at a low volume level, e.g., below a threshold listening level. For example, if listener 110 is listening at a low volume level, e.g., “softly,” external audio sounds may be expected to be heard above such a low listening level.

In accordance with embodiments of the present invention, a visual alert 270 may be presented on sound source 230, if available. Embodiments in accordance with the present invention are well suited to a variety of visual indicators that may be used to indicate an audio alert, including, for example, light emitting diodes (LEDs), display screens, e.g., liquid crystal displays (LCDs) and/or organic LED displays (OLED) and light sources used to illuminate display screens, e.g., LEDs and/or electro-luminescent (EL) light sources.

In accordance with embodiments of the present invention, a variety of particular sound patterns in external acoustic sound 250 may trigger sound source device 230 to generate an audio alert message 260. Such particular sound patterns include, for example, user-selectable spoken sequences, e.g., a listener 110's name, or phrases such as “Hey!”, “Psssst!”, “Fire,” “Evacuate” and the like. Particular sound patterns may also include, for example, non-speech sounds, e.g., car or train horns, fire alarms and/or emergency vehicle sirens. Particular sound patterns to trigger audio alert messages may be “registered” with sound source device 230 in any suitable manner. For example, particular sound patterns may be added by a user 110, e.g., “learned” or “trained” into sound source device 230 as is well known in the sound/voice recognition arts. In addition, particular sound patterns to trigger audio alert messages may be pre-programmed by a manufacturer or “app” supplier for sound source 230.

In addition, in accordance with embodiments of the present invention, any external acoustic sound 250 of greater than a threshold magnitude, e.g., 110 dBa, may trigger an audio alert message 260.

Generally, such an alert message should notify listener 110 to pay increased attention to the listener 110's surroundings, although that is not required. In accordance with embodiments of the present invention, audio alert message 260 may take any suitable form to divert listener 110's attention away from the regular audio program of sound source 230, and direct listener 110's attention to the source of external acoustic sound 250. Example alert messages 260 include, for example, tone signals, e.g., “beeps” or “boops,” silence, e.g., muting or attenuating the regular audio program of sound source 230, or a pre-recorded speech message, e.g., “someone is calling you.” In addition, an alert message 260 may comprise muting the regular audio program of sound source device 230 and passing external acoustic sound 250 to headphones 120. For example, audio alert message 260 may comprise external acoustic sound 250 as received by acoustic sound receiver 236, and passed from sound source 240 to headphones 120 via coupling 135.

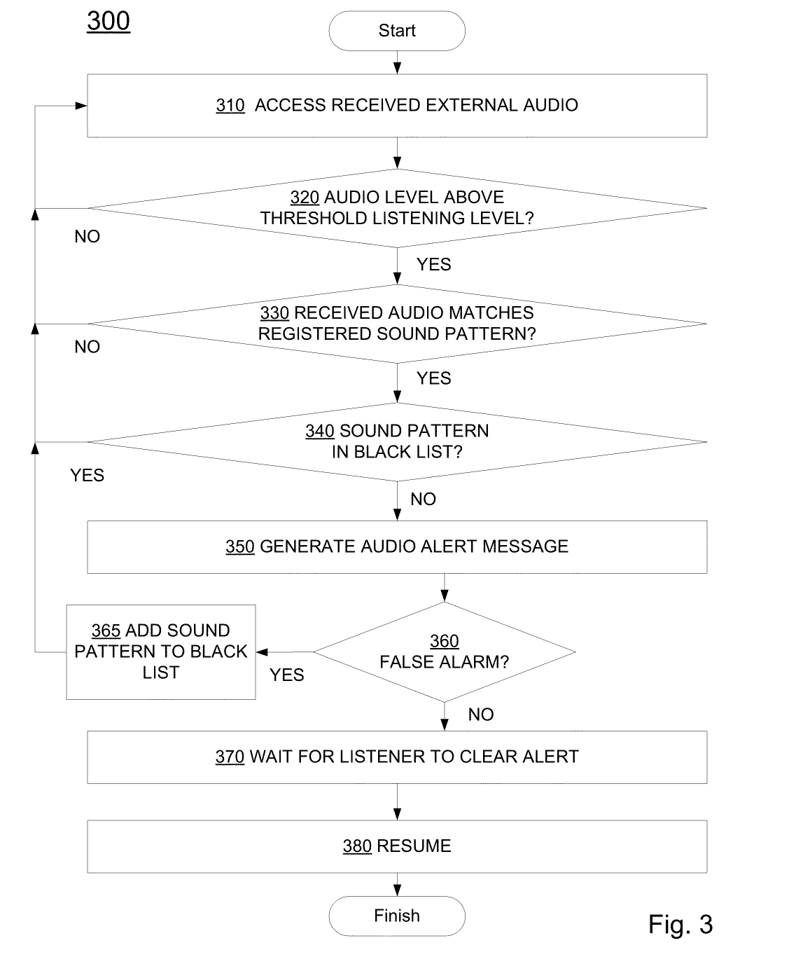

FIG. 3 illustrates a method 300, in accordance with embodiments of the present invention. In 310, external audio, e.g., external acoustic sound 250 of FIG. 2, is received at sound source 230, for example via acoustic sound receiver 236. In optional 320, the audio playback level, e.g., as provided by sound source device 230 to headphones 120, is compared to a threshold listening level. If the audio playback level is below the threshold value, process flow reverts to 310. For example, if the audio playback level is sufficiently low or “soft,” a listener, e.g., listener 110, may be expected to hear external acoustic sound 250 directly, e.g., “over” the audio playback, and may not need an audio alert message.

In 330, the received audio is analyzed to determine if the received audio comprises any “particular” or registered sound patterns. If no registered sound patterns are found in the received audio, process control reverts to 310. In optional 340, any matched sound pattern is checked against a “black list.” The black list comprises a list of false positive sound patterns. For example, an item in the black list represents an sound pattern that has been processed by sound source device 230 as being a registered sound pattern, but has been “marked” or otherwise indicated, e.g., in 365, below, as a sound pattern for which a user, e.g., listener 110, does not desire an audio alert message. Such false positive sound pattern matches may occur, for example, with similar sounding proper names.

In 350, responsive to matching a received sound pattern, an audio alert message is generated. In addition, the audio program may optionally be paused, e.g., to enable the listener to responds to the audio alert message. As previously presented, an audio alert message may take any suitable form, including, for example, and audio alert message, e.g., audio alert message 260 of FIG. 2, may take any suitable form to divert a listener's, e.g., listener 110, attention away from a regular audio program, and direct attention to the source of an external acoustic sound, e.g., external acoustic sound 250. Example alert messages may include, for example, tone signals, e.g., “beeps” or “boops,” silence, e.g., muting or attenuating a regular audio program, or a pre-recorded speech message, e.g., “someone is calling you.” In addition, an audio alert message may comprise muting the regular audio program of a sound source and passing the matched external acoustic sound to the headphones.

In optional 360, a listener may indicate that an audio alert message was in error. For example, responsive to an audio alert message, a listener takes off his headphones, and determines that a nearby co-worker was speaking, but not addressing the listener. Such a scenario may indicate a “false alarm” or false positive, e.g., an audio alert message was generated in error. In such a case, a listener may indicate that the recognized sound pattern should be added (365) to the “black list,” to avoid a subsequent occurrence of such a false positive.

In optional 370, a sound source, e.g., sound source device 230 of FIG. 2, waits for a user, e.g., listener 110, to indicate, e.g., via a control input to a sound source, that playback of an audio program should be resumed. In 380, playback of an audio program is resumed.

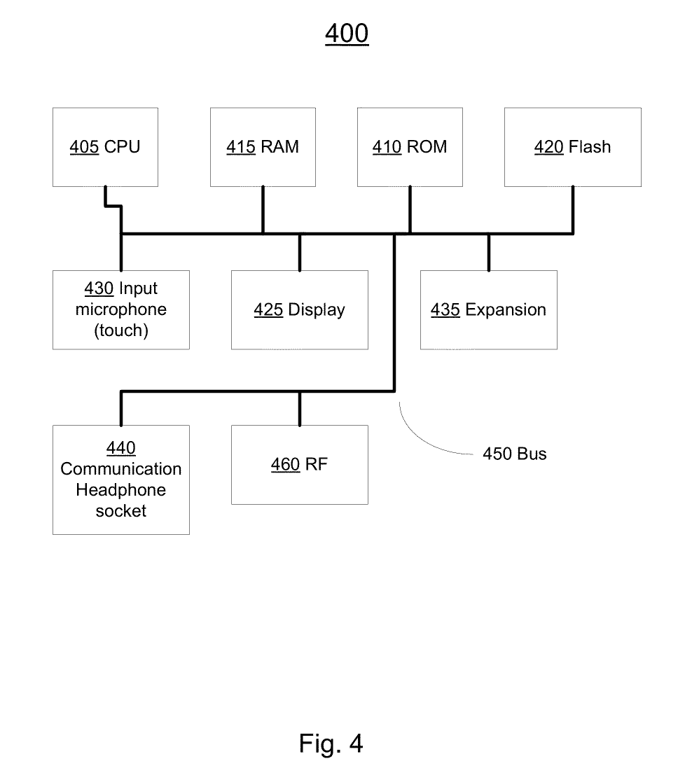

FIG. 4 is an exemplary block diagram of an exemplary electronic system 400, which may be used as a platform to implement embodiments of the present invention. For example, sound source device 230 of FIG. 2 may comprise an embodiment of electronic system 400. Electronic system 400 may be battery-powered, in some embodiments. Electronic system 400 includes an address/data bus 450 for communicating information, a central processor 405 functionally coupled with the bus for processing information and instructions. Central processor 405 may comprise multiple processors, e.g., a multi-core processor, or multiple separate processors, in some embodiments. Central processor 405 may comprise a digital signal processor (DSP) in some embodiments. The configuration shown for electronic system 400 is exemplary, and may comprise any suitable bus configuration, alone or in combination, including, for example, Von Neumann or Harvard bus architectures.

Electronic system 400 also includes a volatile memory 415 (e.g., random access memory RAM) coupled with the bus 450 for storing information and instructions for the central processor 405, and a non-volatile memory 410 (e.g., read only memory ROM) coupled with the bus 450 for storing static information and instructions for the processor 405. Electronic system 400 also optionally includes a changeable, non-volatile memory 420 (e.g., flash) for storing information and instructions for the central processor 405 and/or program content, e.g., MP3 files, which can be updated after the manufacture of system 400. In some embodiments, only one of ROM 410 or Flash 420 may be present.

Also included in electronic system 400 of FIG. 4 is an optional input device 430. Device 430 can communicate information and command selections to the central processor 400. Input device 430 may be any suitable device for communicating information and/or commands to the electronic system 400. For example, input device 430 may take the form of buttons, a joystick, a track ball, an audio transducer, e.g., a microphone, for example acoustic sound receiver 236 of FIG. 2, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 430 of the electronic system 400, in some embodiments. For example, capacitive touch panels may sense proximity of a user's finger or an eyeball scanner may detect a direction of a user's gaze.

Electronic system 400 may comprise a display unit 425. The display unit 425 utilized with the electronic system 400 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 425 may comprise a limited number of display elements, e.g., a single LED, in some embodiments. Display unit 425 may have an associated lighting device, e.g., an electro-luminescent (EL) panel or an LED back light, in some embodiments. Display unit 425 may comprise a weapon-mounted and/or head-mounted display, in some embodiments.

A touch sensitive digitizer panel 430 may generally associated with the display unit 425. For example, a function of the touch sensitive digitizer panel 430 generally associated with the display unit 425 is to localize a touch input, e.g., from a finger or stylus, to a portion of display unit 425, for example, a single icon image displayed on display unit 425. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 430 may have different planar dimensions in comparison to planar dimensions of a display unit 425. For example, the touch sensitive digitizer panel 430 may be smaller than display unit 425, e.g., the display unit 425 may extend beyond the touch sensitive digitizer panel 430. Similarly, the touch sensitive digitizer panel 430 may be larger than display unit 425, e.g., the touch panel may extend beyond the display unit. The touch sensitive digitizer panel may be integral to a display assembly, or a separate assembly within the electronic system 400.

Electronic system 400 also optionally includes an expansion interface 435 coupled with the bus 450. Expansion interface 435 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 435 may consist of signals substantially compliant with the signals of bus 450.

A wide variety of well known devices may be attached to electronic system 400 via the bus 450 and/or expansion interface 435. Examples of such devices include without limitation rotating magnetic memory devices, flash memory devices, digital cameras, wireless communication modules, digital audio players and Global Positioning System (GPS) devices.

System 400 also optionally includes a communication port 440. Communication port 440 may be implemented as part of expansion interface 435. Communication port 440 may comprise an analog “headphone” socket, e.g., comprising tip, ring and sleeve contacts, for use with commonly available headphones or ear buds. Communication port 440 may comprise additional contacts, e.g., for an external microphone, in some embodiments. When implemented as a separate interface, communication port 440 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 400 optionally includes a radio frequency module 460, which may implement a mobile telephone, a wireless network, e.g., IEEE 802.11 (“Wi-Fi”), Bluetooth, a pager, or a digital data link. Radio frequency module 460 may be interfaced directly to bus 450, via communication port 440, via expansion interface 435, or any suitable interface. Various features of electronic system 400 may be implemented by a combination of hardware and/or software. Electronic system 400 may comprise additional software and/or hardware features (not shown) in some embodiments.

Embodiments in accordance with the present invention provide systems and methods for alerts based on recognition of a particular sound pattern. In addition, embodiments in accordance with the present invention provide systems and methods for alerts based on recognition of a particular sound pattern that interrupt an audio program being played over headphones. Further, embodiments in accordance with the present invention provide systems and methods for alerts based on recognition of a particular sound pattern that are compatible and complementary with existing systems and methods of electronic device design and manufacture, and digital signal processing.

Various embodiments of the invention are thus described. While the present invention has been described in particular embodiments, it should be appreciated that the invention should not be construed as limited by such embodiments, but rather construed according to the below claims.

What is claimed is:

1. A method comprising:
while playing an audio program to headphones, accessing received external audio;
matching said received external audio to at least one of a plurality of registered sound patterns; and
responsive to said matching, generating an audio alert message to said headphones.

2. The method of claim 1 further comprising:
determining if a playback level of said audio program is above a threshold listening level; and
performing said matching and said generating only if said playback level of said audio program is above said threshold listening level.

3. The method of claim 1 further comprising:
responsive to said matching, comparing said received external audio to a black list of sound patterns; and
if said received external audio corresponds to one of said black list of sound patterns, terminating said method.

4. The method of claim 3 further comprising:
accessing a user input to identify said audio alert message as a false positive; and
responsive to said user input, adding said received external audio to said black list of sound patterns

5. The method of claim 1 further comprising:
waiting for a user input to clear said audio alert message; and
resuming said audio program.

6. The method of claim 1 wherein said audio alert message comprises muting said audio program.

7. The method of claim 1 wherein said audio alert message comprises said received external audio.

8. The method of claim 1 wherein said audio alert message comprises a visual indicator.

9. An apparatus comprising:
a sound source device for playing an audio program to headphones;
an acoustic sound receiver coupled to said sound source device for receiving external audio;
said sound source device also for matching received external audio to at least one of a plurality of registered sound patterns; and
said sound source device also for generating an audio alert message to said headphones responsive to said matching.

10. The apparatus of claim 9 wherein said sound source device is also for:
determining if a playback level of said audio program is above a threshold listening level; and
performing said matching and said generating only if said playback level of said audio program is above said threshold listening level

11. The apparatus of claim 9 wherein said sound source device is also for:
responsive to said matching, comparing said received external audio to a black list of sound patterns; and
if said received external audio corresponds to one of said black list of sound patterns, not generating said audio alert message.

12. The apparatus of claim 9 wherein said sound source device is also for:
waiting for a user input to clear said audio alert message; and
resuming said audio program.

13. The apparatus of claim 9 wherein:
said audio alert message comprises muting said audio program.

14. The apparatus of claim 9 wherein:
said audio alert message comprises said received external audio.

15. The apparatus of claim 9 wherein:
said sound source device comprises a visual indicator; and
said audio alert message comprises said visual indicator.

16. An article of manufacture including a computer readable medium having stored therein instructions that, responsive to execution by a computer system, cause the computer system to perform operations comprising:
while playing an audio program to headphones, accessing received external audio;
matching said received external audio to at least one of a plurality of registered sound patterns; and
responsive to said matching, generating an audio alert message to said headphones.

17. The article of manufacture of claim 16 wherein said operations further comprise:
determining if a playback level of said audio program is above a threshold listening level; and
performing said matching and said generating only if said playback level of said audio program is above said threshold listening level.

18. The article of manufacture of claim 16 wherein said operations further comprise:
responsive to said matching, comparing said received external audio to a black list of sound patterns; and
if said received external audio corresponds to one of said black list of sound patterns, terminating said method.

19. The article of manufacture of claim 16 wherein said operations further comprise:
waiting for a user input to clear said audio alert message; and
resuming said audio program.

20. The article of manufacture of claim 16 wherein said operations further comprise:
muting said audio program as part of said audio alert message.
